(19) United States
(12) Patent Application Publication
(10) Pub. No.: US 2025/0365493 A1
(43) Pub. Date: Nov. 27, 2025

(54) IMAGE SENSING DEVICE

(71) Applicant: GUANGZHOU LUXVISIONS INNOVATION TECHNOLOGY LIMITED, Guangzhou City (CN)

(72) Inventors: Jyun-Jie Lin, Guangzhou City (CN); Tsung-Kai Chang, Guangzhou City (CN)

(73) Assignee: GUANGZHOU LUXVISIONS INNOVATION TECHNOLOGY LIMITED, Guangzhou City (CN)

(21) Appl. No.: 19/003,895

(22) Filed: Dec. 27, 2024

(30) Foreign Application Priority Data
May 27, 2024 (CN) 202410667747.6

(51) Int. Cl. H04N 23/54

(52) U.S. Cl. CPC H04N 23/54

(57) ABSTRACT

An image sensing device includes a sensing module, a base, a movable member, a bearing assembly, and a plurality of memory metal elements. The sensing module includes a circuit board and a photosensitive element. The circuit board has a movable portion, a frame portion, and a plurality of connecting portions. The connecting portions are connected to the movable portion and the frame portion. The photosensitive element is located in the movable portion. The movable portion is located in the movable member. The bearing assembly is located between the movable member and the base, so that the movable member is displaceable on a plane relative to the base. The memory metal elements are connected to the base and the movable member, and are electrically connected to the frame portion. When the memory metal elements are driven, the movable member is actuated to move on the plane relative to the base.

### CROSS-REFERENCE TO RELATED APPLICATION

This non-provisional application claims priority under 35 U.S.C. § 119(a) to patent application No. 202410667747.6 filed in China on May 27, 2024, the entire contents of which are hereby incorporated by reference.

### BACKGROUND

### Technical Field

The present invention relates to an image sensing device, and in particular, to an image sensing device that provides vibration compensation.

### Related Art

With the development of science and technology, the shooting function of an electronic product is constantly evolving in pursuit of professional and simpler operation experience. To meet the requirements, a modern photographic device is usually equipped with an image sensing device. However, during shooting by a user, a hand shake or jitter often leads to a blurred picture. Therefore, the image sensing device needs to provide optical image stabilization (OIS) for vibration compensation.

### SUMMARY

In view of this, the applicant proposes an image sensing device, including a sensing module, a base, a movable member, a bearing assembly, and a plurality of memory metal elements. The sensing module includes a circuit board and a photosensitive element. The circuit board has a movable portion, a frame portion, and a plurality of connecting portions. The connecting portions are connected to the movable portion and the frame portion. The photosensitive element is located in the movable portion. The movable portion is located in the movable member. The bearing assembly is located between the movable member and the base, so that the movable member is displaceable on a plane relative to the base. The memory metal elements are connected to the base and the movable member, and are electrically connected to the frame portion. When the memory metal elements are driven, the movable member is actuated to move on the plane relative to the base.

Based on the above, according to some embodiments of the present disclosure, in the image sensing device, the sensing module, the base, the movable member, the bearing assembly, and the plurality of memory metal elements are connected, and the bearing assembly between the movable member and the base reduces a friction force between the movable member and the base. When the memory metal elements are driven, the memory metal elements are connected to the base and the movable member, and the photosensitive element is located in the movable member, causing the movable member to move on the plane relative to the base and drive the photosensitive element to move on the plane when the memory metal elements are actuated, to achieve an effect of vibration compensation.

### BRIEF DESCRIPTION OF THE DRAWINGS

FIG. 1 is a three-dimensional view of an image sensing device according to some embodiments of the present disclosure;

FIG. 2 is an exploded view of a front side of an image sensing device according to some embodiments of the present disclosure;

FIG. 3 is an underside exploded view of an image sensing device according to some embodiments of the present disclosure;

FIG. 4 is a three-dimensional view of an image sensing device with a circuit board and a housing being removed according to some embodiments of the present disclosure;

FIG. 5 is a top view of an image sensing device with a circuit board and a housing being removed according to some embodiments of the present disclosure;

FIG. 6 is a three-dimensional view of an image sensing device with a circuit board and a housing being removed according to some other embodiments of the present disclosure;

FIG. 7 is a cross-sectional side view taken along line A-A marked in FIG. 1; and

FIG. 8 is a cross-sectional side view taken along line B-B marked in FIG. 1.

### DETAILED DESCRIPTION

When a term “include”, “comprise”, or “have” is used in recorded content of this specification, unless otherwise stated, it may further include another element, assembly, structure, region, component, device, system, step, connection, and the like, and other specifications should not be excluded. When terms “upper”, “lower”, “bottom”, “left”, “right”, “inner”, and “outer” are used to describe the technical content or relative relationships of embodiments of the present invention only, unless otherwise indicated, they are not intended to limit the scope of application of the present invention. Therefore, provided that any adjustment, interchange, or alteration of relative positions and relationships does not substantially change the technical content of the present invention, it shall fall within the scope of the claims of the present invention.

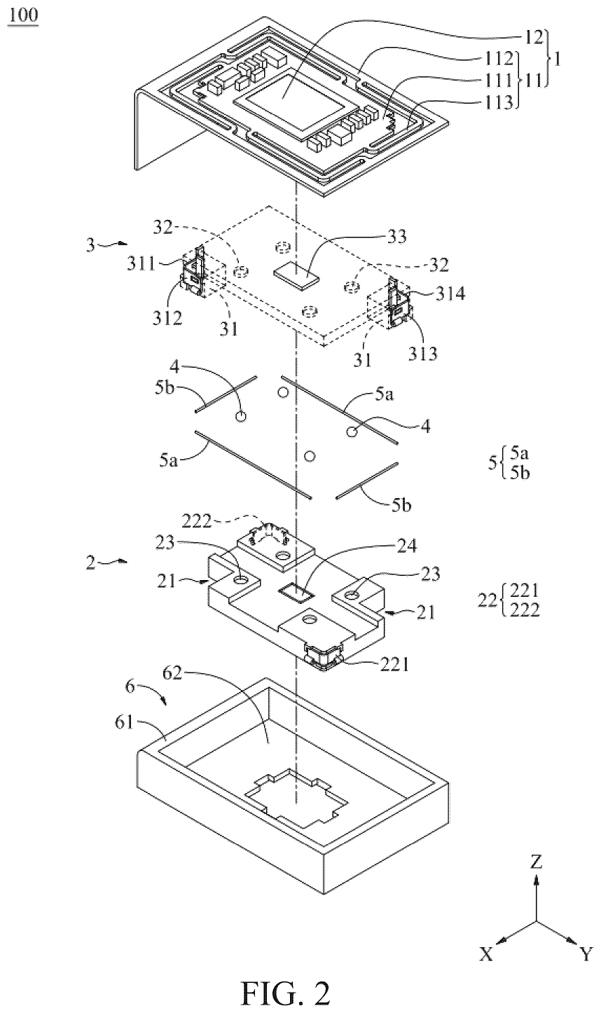

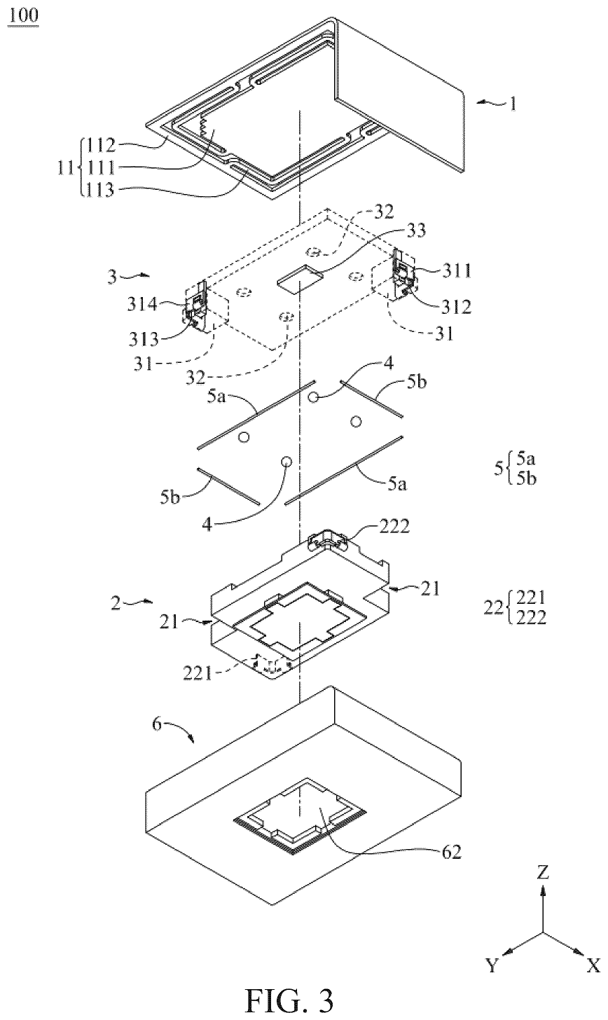

When terms “first”, “second”, and the like that indicate a sequence are used only for the convenience of describing or distinguishing specifications such as elements, assemblies, structures, regions, components, devices, and systems, the terms are not intended to limit the scope of application of the present invention, nor to limit a spatial order relationship among such specifications. In addition, unless otherwise stated, the singular term “one” in this specification is also applicable to a plurality of usage contexts, and terms “or” and “and/or” may also be used interchangeably. To describe the present disclosure more clearly, in the accompanying drawings provided in the present disclosure, a first axis X is an X-axis of a three-dimensional coordinate system, a second axis Y is a Y-axis of the three-dimensional coordinate system, and a third axis Z is a Z-axis of the three-dimensional coordinate system. It should be noted that, to facilitate understanding of a detailed structure of an image sensing device, some elements in each accompanying drawing may be represented by dashed lines to avoid occluding other elements (such as a movable member 3 in FIG. 2 and FIG. 3). This representation is unrelated to a structure, a material, and a relative position of each element during implementation.

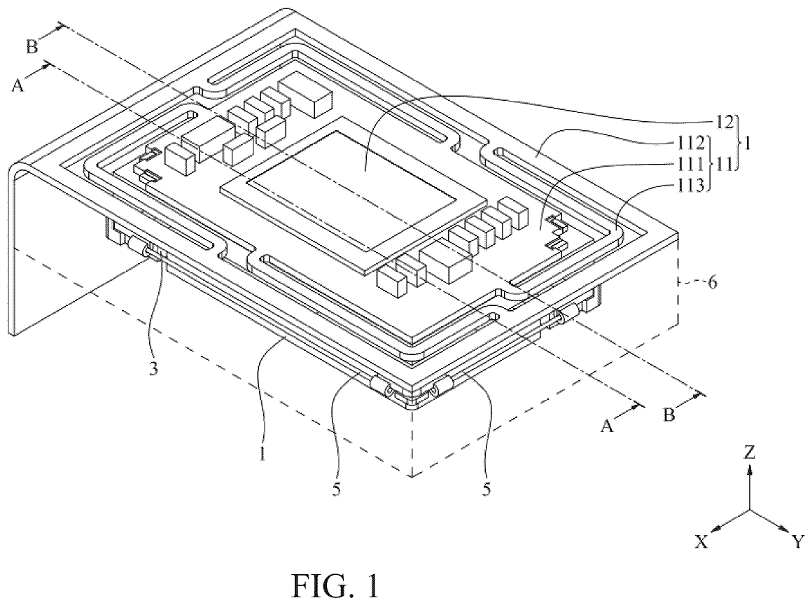

FIG. 1 is a three-dimensional view of an image sensing device according to some embodiments of the present disclosure. FIG. 2 is an exploded view of a front side of an image sensing device according to some embodiments of the present disclosure. FIG. 3 is an underside exploded view of an image sensing device according to some embodiments of the present disclosure. Refer to FIG. 1 to FIG. 3 together. An image sensing device 100 includes a sensing module 1, a base 2, a movable member 3, a bearing assembly 4, and a plurality of memory metal elements 5. The movable member 3 is arranged between the sensing module 1 and the base 2. The bearing assembly 4 is arranged between the base 2 and the movable member 3, so that the movable member 3 is displaceable on a plane relative to the base 2. The plurality of memory metal elements 5 are connected to the base 2 and the movable member 3. The sensing module 1 may be, but is not limited to, a charge-coupled device (CCD) or a complementary metal-oxide-semiconductor active pixel sensor (CMOS active pixel sensor). The bearing assembly 4 is configured to provide support for the base 2 and the movable member 3 and maintain a spacing between the base and the movable member, and allows the base 2 and the movable member 3 to move relative to each other. For example, the bearing assembly 4 is a sphere or a roller. The memory metal element 5 is connected to the base 2 and the movable member 3, and is electrically connected to a frame portion 112. In some embodiments, when the memory metal element 5 is driven, the movable member 3 is actuated to move on a plane formed by a first axis X and a second axis Y relative to the base 2. The memory metal element 5 is made of a shape memory alloy (SMA). A material thereof is selected from a group consisting of an iron-based alloy, a nickel-titanium alloy, a copper-based alloy, zinc, and aluminum.

Referring to FIG. 1, the sensing module 1 includes a circuit board 11 and a photosensitive element 12. The circuit board 11 includes a movable portion 111, a frame portion 112, and a plurality of connecting portions 113. The connecting portion 113 connects the movable portion 111 and the frame portion 112. The photosensitive element 12 is located in the movable portion 111. The movable portion 111 is located in the movable member 3. The movable portion 111 is located in the middle of the frame portion 112. The connecting portion 113 may be a flexible flat cable, and connects the movable portion 111 and the frame portion 112, so that the movable portion 111 is suspended and moved in the frame portion 112 through flexibility of the flexible flat cable. In this embodiment, the circuit board 11 is a flexible printed circuit (FPC), for example, a substrate made of polyimide (PI) or polyethylene terephthalate (PET). The connecting portion 113 is the flexible flat cable included in the FPC. Benefiting from flexibility of the FPC, so that the movable portion 111 has a specific degree of mobility within the frame portion 112. For example, a trench may be formed on the FPC by etching or laser. An outermost periphery of the FPC forms the frame portion 112. The FPC between two trenches forms the connecting portion 113. The FPC with a center being not removed forms the movable portion 111. The photosensitive element 12 and another electronic element may be mounted above the movable portion 111 of the circuit board 11. The foregoing element moves together with the movable portion 111. In another embodiment, an upper part or a surface of the photosensitive element 12 may be covered with a filter (for example, blue light glass, not shown in the figure). The filter also moves together with the movable portion 111. The sensing module 1 of this embodiment includes four connecting portions 113, which are respectively connected to four inner side surfaces of the frame portion 112 and four outer side surfaces of the movable portion 111. In this embodiment, to improve a degree of freedom of movement of the movable portion 111 in a direction of the first axis X and a direction of the second axis Y, a trench is provided between the connecting portion 113 and the movable portion 111. A trench is also provided between the connecting portion 113 and the frame portion 112. Specifically, referring to FIG. 1, a leftmost connecting portion 113 is connected to a left side of the frame portion 112. The foregoing connecting portion 113 extends along a negative direction of the first axis X and then turns at a corner of the frame portion 112 and continues to extend along a positive direction of the second axis Y, and finally is connected to an upper side of the movable portion 111. The foregoing connecting portion 113 forms an “L”-shaped structure, and maintains a distance from both the movable portion 111 and the frame portion 112. The other three connecting portions 113 of this embodiment also adopt the foregoing design, so as to jointly achieve an effect of suspending the movable portion 111 and simultaneously allowing the movable portion 111 to move on the plane formed by the first axis X and the second axis Y.

Refer to FIG. 2 and FIG. 3. In some embodiments, the image sensing device 100 includes a sensing module 1, a base 2, a movable member 3, a bearing assembly 4, a plurality of memory metal elements 5, and a housing 6. The housing 6 has a groove edge 61 and a groove 62. The base 2, the movable member 3, the bearing assembly 4, and the memory metal elements 5 are all arranged in the groove 62. A frame portion 112 of the circuit board 11 is connected to the groove edge 61. The base 2 is fixed to a bottom of the groove 62 (referring to FIG. 3, for example, the base 2 has a bump at a bottom that may be inserted into a hole at the bottom of the groove 62). The frame portion 112 and the base 2 are both fixed to the housing 6, and the movable portion 111 is fixed to the movable member 3. When the memory metal elements 5 are driven, the movable member 3 is actuated to move on the plane formed by the first axis X and the second axis Y relative to the base 2, and the movable member 3 drives the movable portion 111 of the circuit board 11 to move relative to the frame portion 112. In some embodiments, the FPC may extend from a side of the frame portion 112. The extended part may include a flat cable and may be fixed to an outer side of the groove 62.

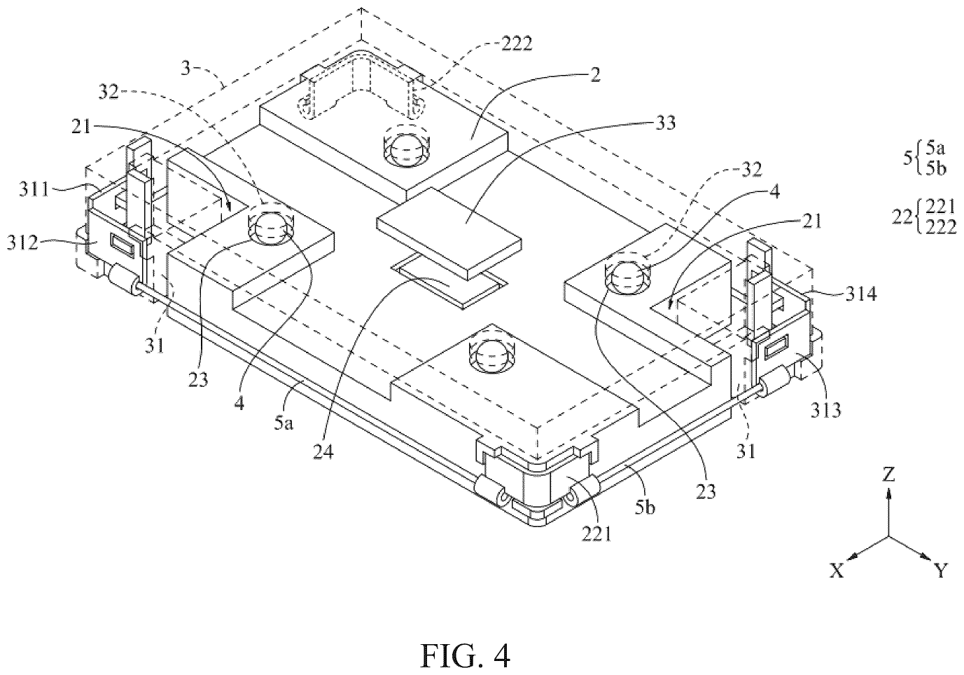

FIG. 4 is a three-dimensional view of an image sensing device with a circuit board and a housing being removed according to some embodiments of the present disclosure. Refer to FIG. 4. In this embodiment, a base 2 and a movable member 3 are rectangular. Block portions 31 are respectively arranged at a pair of opposite corners of the movable member 3 towards the base 2 along a third axis Z. Accommodating portions 21 are arranged at a pair of opposite corners of the base 2 corresponding to the block portion 31. Turning portions 22 are arranged at another pair of opposite corners of the base 2 corresponding to the block portion 31. Two turning portions 22 are respectively provided with a first turning sheet 221 and a second turning sheet 222. In this embodiment, the two block portions 31 are cubes. A shape of the accommodating portion 21 corresponds to a shape of the block portion 31. A square-shaped space having a slightly larger size than the block portion 31 is formed. Therefore, when the base 2 and the movable member 3 are combined to form a cube, and a size of the accommodating portion 21 is slightly greater than that of the block portion 31, a movable space is defined between the base 2 and the movable member 3. The accommodating portion 21 of the base 2 provides a limiting function for movement of the movable member 3 on an XY plane. Specifically, in the embodiment of FIG. 4, when the movable member 3 continuously moves along the positive direction of a second axis Y, the block portion 31 on a left side of the movable member 3 is blocked by an inner wall of the accommodating portion 21 on a left side of the base 2. When the movable member 3 continuously moves along a negative direction of the second axis Y, the block portion 31 on a right side of the movable member 3 is blocked by an inner wall of the accommodating portion 21 on a right side of the base 2. Similarly, when the movable member 3 continuously moves along a positive direction of a first axis X, the block portion 31 on the right side of the movable member 3 is blocked by the inner wall of the accommodating portion 21 on the right side of the base 2. When the movable member 3 continuously moves along the negative direction of the first axis X, the block portion 31 on the left side of the movable member 3 is blocked by the inner wall of the accommodating portion 21 on the left side of the base 2. For design of a spacing between the accommodating portion 21 and the block portion 31, a requirement for amplitude compensation of optical image stabilization (OIS) and flexibility of the connecting portion 113 of the circuit board 11 may be considered. The shape of the block portion 31 does not necessarily have to be a cube. For example, the block portion 31 of the movable member 3 may be ¼ of a cylinder (not shown in the figure). The accommodating portion 21 of the base 2 may be an arc surface. A radius of curvature of the arc surface is slightly greater than ¼ of a radius of the cylinder.

Referring to FIG. 4 again, in this embodiment, the movable member 3 has a first conductive sheet 311, a second conductive sheet 312, a third conductive sheet 313, and a fourth conductive sheet 314. An outer side of the block portion 31 forms two side surfaces at the pair of opposite corners of the movable member 3. One side surface thereof is parallel to an XZ plane, and the other side surface is parallel to a YZ plane. The first turning sheet 221 and the second turning sheet 222 each have two side surfaces. One side surface thereof is parallel to the XZ plane, and the other side surface is parallel to the YZ plane. The first conductive sheet 311 is arranged on a side surface of one block portion 31 parallel to the XZ plane. The second conductive sheet 312 is arranged on a side surface of the block portion 31 parallel to the YZ plane. The first conductive sheet 311 and the second conductive sheet 312 are not in electrical communication with each other. The third conductive sheet 313 is arranged on a side surface of the other block portion 31 parallel to the XZ plane. The fourth conductive sheet 314 is arranged on a side surface of the other block portion 31 parallel to the XY plane. The third conductive sheet 313 and the fourth conductive sheet 314 are not in electrical communication each other. Therefore, the first conductive sheet 311 and the third conductive sheet 313 move with the movable member 3 towards the second axis Y. The second conductive sheet 312 and the fourth conductive sheet 314 move with the movable member 3 towards the first axis X.

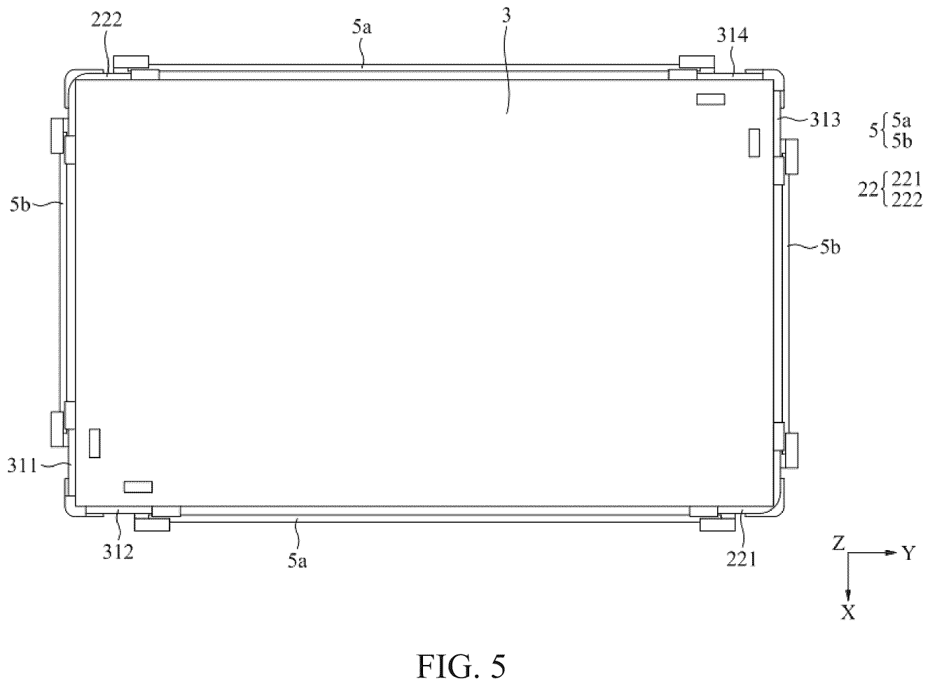

FIG. 5 is a top view of an image sensing device with a circuit board and a housing being removed according to some embodiments of the present disclosure. Refer to FIG. 5. In this embodiment, a memory metal element 5 is of a strip-shaped structure and arranged on a side edge of a movable portion 111 (or a base 2). An extending direction of each strip-shaped structure is parallel to a direction of a first axis X or a direction of a second axis Y, so as to allow the strip-shaped structure to drive the movable portion 111 to move along the direction of the first axis X or the direction of the second axis Y when stretching or retracting. The memory metal element 5 includes two first memory metal elements 5a (first SMA elements) and two second memory metal elements 5b (second SMA elements). The first memory metal elements 5a and the second memory metal elements 5b are arranged to have two dimensions corresponding to a length or a width of the movable portion 111 (or the base 2). Refer to a lower side of FIG. 5. A second conductive sheet 312, one of the first memory metal elements 5a, a first turning sheet 221, one of the second memory metal elements 5b, and a third conductive sheet 313 are electrically connected in sequence. Refer to a left side of FIG. 5. A first conductive sheet 311, the other of the second memory metal elements 5b, a second turning sheet 222, the other of the first memory metal elements 5a, and a fourth conductive sheet 314 are electrically connected in sequence. Specifically, one of the first memory metal elements 5a is connected to the first turning sheet 221 and the second conductive sheet 312, and one of the second memory metal elements 5b is connected to the first turning sheet 221 and the third conductive sheet 313, to jointly form an “L”-shaped connection path. The other of the first memory metal elements 5a is connected to the second turning sheet 222 and the fourth conductive sheet 314, and the other of the second memory metal elements 5b is connected to the second turning sheet 222 and the first conductive sheet 311, to jointly form an “L”-shaped connection path.

Therefore, the second conductive sheet 312, the first memory metal element 5a, the first turning sheet 221, the second memory metal element 5b, and the third conductive sheet 313 form a first circuit. The first conductive sheet 311, the other second memory metal element 5b, the second turning sheet 222, the other first memory metal element 5a, and the fourth conductive sheet 314 form a second circuit. Refer to FIG. 2 and FIG. 5 together. The first conductive sheet 311, the second conductive sheet 312, the third conductive sheet 313, and the fourth conductive sheet 314 of the movable member 3 are electrically connected to the movable portion 111 of the circuit board 11. The movable portion 111 of the circuit board 11 is electrically connected to the frame portion 112 through the connecting portion 113. The frame portion 112 may be electrically connected to an external module (not shown in the figure) through a flat cable of the FPC. Therefore, in some embodiments, the external module may send different electrical signals to the first circuit and the second circuit, so that each memory metal element 5 experiences retraction changes to varying degrees as a result of heating due to being energized, thereby causing the movable member 3 to move and controlling a position of the movable portion 111 of the circuit board 11 relative to the frame portion 112.

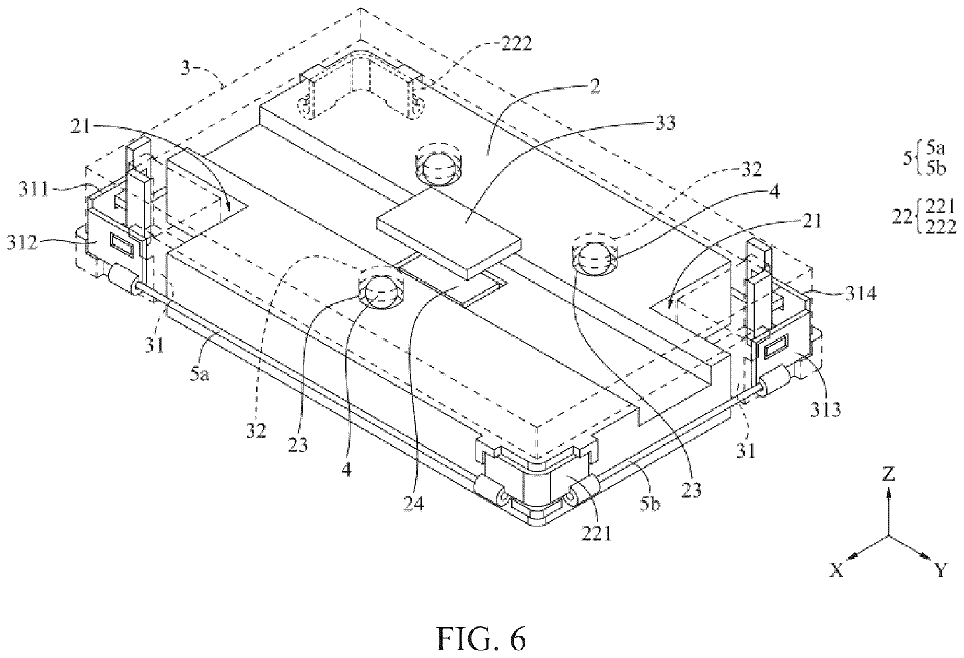

Refer to FIG. 4 again. In this embodiment, bearing assemblies 4 are four spheres. Each of the spheres is located between the movable member 3 and the base 2, so that the movable member 3 is displaceable on a plane formed by the first axis X and the second axis Y relative to the base 2. A side of the movable member 3 close to the bearing assembly 4 is provided with four upper grooves 32 corresponding to the four spheres. A side of the base 2 close to the bearing assembly 4 is provided with four lower grooves 23 corresponding to the four spheres. The four spheres may be arranged as a rectangle and arranged at four end points of the rectangle. The upper grooves 32 and the lower grooves 23 are arranged in positions corresponding to the four end points, so that the movable member 3 and the base 2 are borne at a uniform force. To maintain a state in which the movable member 3 is parallel to the base 2, at least three or more bearing assemblies 4 may be arranged. FIG. 6 is a three-dimensional view of an image sensing device with a circuit board and a housing being removed according to some other embodiments of the present disclosure. Refer to FIG. 6. In this embodiment, bearing assemblies 4 are three spheres. Each of the spheres is located between a movable member 3 and a base 2, so that the movable member 3 is displaceable on a plane formed by a direction of a first axis X and a direction of a second axis Y relative to the base 2. A side of the movable member 3 close to the bearing assembly 4 is provided with three upper grooves 32 corresponding to the three spheres. A side of the base 2 close to the bearing assembly 4 is provided with three lower grooves 23 corresponding to the three spheres. The three spheres may be arranged as a regular triangle and arranged at three corner points of the triangle. The upper grooves 32 and the lower grooves 23 are arranged in positions corresponding to the three corner points, so that the movable member 3 and the base 2 are borne at a uniform force. For an arrangement position of the bearing assembly 4, smoothness of the movable member 3 and the base 2 when moving on the plane formed by the first axis X and the second axis Y needs to be considered. In some embodiments, a center of mass or a geometric center of the movable member 3 and a center of mass or a geometric center of the base 2 are both configured within a range surrounded by a plurality of bearing assemblies 4. In some other embodiments, the center of mass or a center of volume of the movable member 3 and the center of mass or a center of volume of the base 2 are both configured in a direction of a third axis Z of geometric centers of the plurality of bearing assemblies 4.

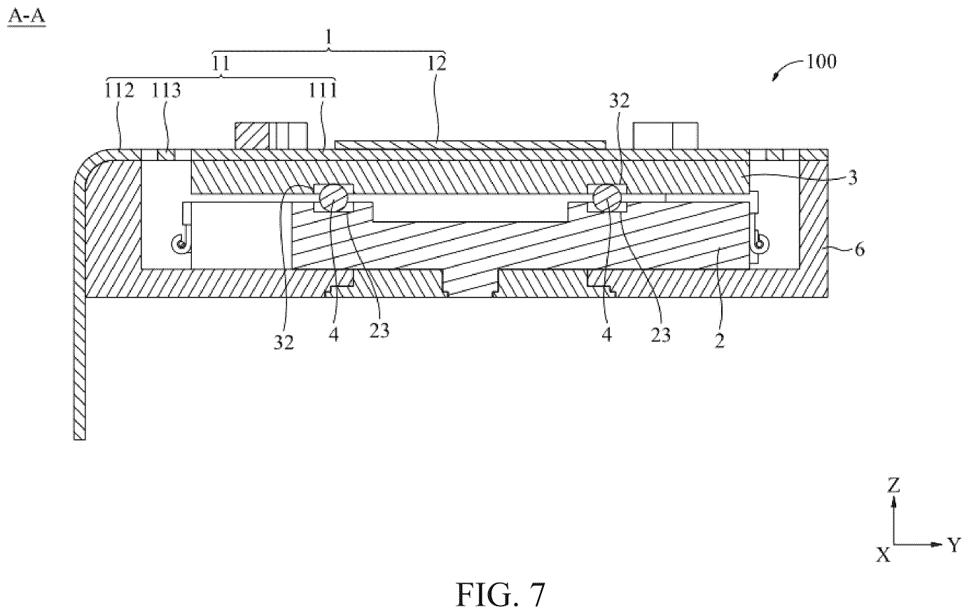

FIG. 7 is a cross-sectional side view taken along line A-A marked in FIG. 1. Refer to FIG. 1, FIG. 4, and FIG. 7 together. In this embodiment, the upper groove 32 and the lower groove 23 are cylindrical grooves. A total depth of the upper groove 32 and the lower groove 23 is not greater than a diameter of a sphere, so that a spacing may be maintained between the movable member 3 and the base 2 to avoid friction. In addition, to maintain an amount of movement between the movable member 3 and the base 2, a diameter of the upper groove 32 and a diameter of the lower groove 23 are each greater than the diameter of the sphere. A ratio among the diameter of the upper groove 32, the diameter of the lower groove 23, and the diameter of the sphere is determined based on the required amount of movement, so that the sphere is limited to roll within a range of the upper groove 32 and the lower groove 23. For design of the amount of movement, a requirement for amplitude compensation of OIS and flexibility of the connecting portion 113 of the circuit board 11 may be considered.

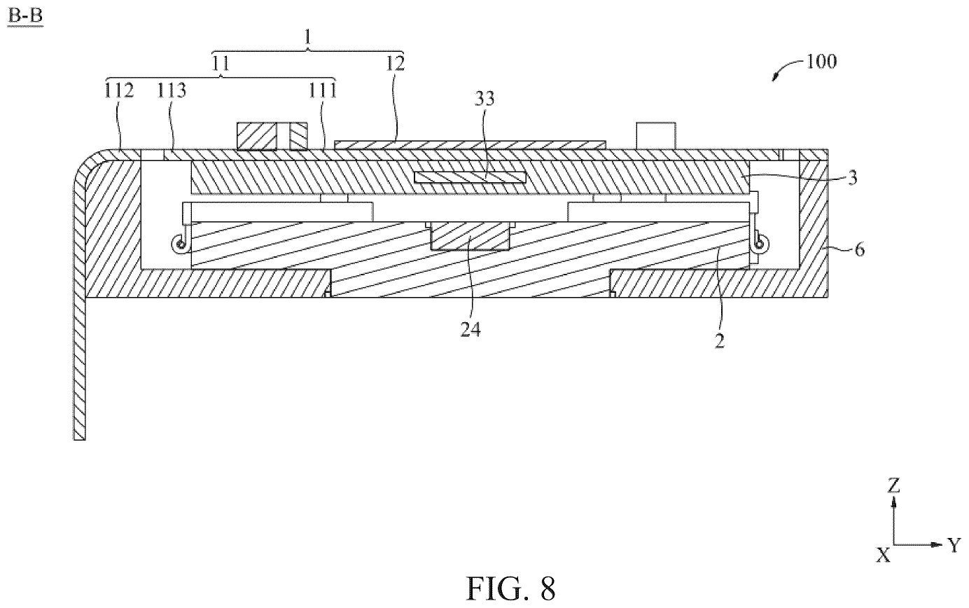

FIG. 8 is a cross-sectional side view taken along line B-B marked in FIG. 1. Refer to FIG. 1, FIG. 4, and FIG. 8 together. In this embodiment, the movable member 3 includes an upper magnetic element 33. The base 2 includes a lower magnetic element 24. The lower magnetic element 24 is arranged in the base 2 corresponding to the upper magnetic element 33. The upper magnetic element 33 and the lower magnetic element 24 attract the movable member 3 and the base 2 by using a magnetic attraction force, to clamp the bearing assembly 4, inhibit the bearing assembly 4 from exceeding beyond a range of the upper groove 32 and the lower groove 23, maintain horizontal movement of the movable member 3 and the base 2, and prevent separation of the movable member and the base, so that an overall structure is stable. Specifically, in this embodiment, a surface between the movable member 3 and the base 2 is movably connected only by the bearing assembly 4. The upper magnetic element 33 and the lower magnetic element 24 generate an attraction force to bring the movable member 3 and the base 2 closer to each other, and the bearing assembly 4 provides a normal force to prevent the movable member 3 from being excessively close to the base 2. The upper magnetic element 33 and the lower magnetic element 24 may both be magnets. Alternatively, one of the upper magnetic element 33 or the lower magnetic element 24 is a magnet and the other is a magnetizer. For example, the movable member 3 has the upper magnetic element 33 of the magnetizer inside, and the base 2 has the lower magnetic element 24 of the magnet inside. In some embodiments, the movable member 3 is a magnetizer, and is attracted to the base 2 by a magnetic force of the magnet arranged on the base 2. Similarly, in some other embodiments, the base 2 is the magnetizer, and is attracted to the movable member 3 by a magnetic force of the magnet arranged on the movable member 3. In some embodiments, the magnet is a permanent magnet, to provide the attraction force to bring the movable member 3 and the base 2 closer to each other.

Based on the above, according to some embodiments, the groove edge of the housing is connected to the frame portion of the sensing module. The groove accommodates the base, the movable member, the bearing assembly, and the memory metal element. The memory metal element is connected to the turning portion of the base and the conductive sheet of the movable member. The conductive sheet of the movable member is connected to the movable portion. The movable portion, the connecting portion, and the frame portion are connected to form a circuit to actuate the memory metal element. When the memory metal element is driven, the movable member moves on the plane formed by the first axis X and the second axis Y relative to the base. The upper magnetic element and the lower magnetic element cause, through a magnetic attraction force, the base and the movable member to keep the bearing assembly fixed between the base and the movable member. The bearing assembly reduces the friction caused by the displacement of the movable member relative to the base. The movable member drives the movable portion to move relative to the plane of the base. The position of the photosensitive element is adjusted to achieve the effect of vibration compensation. The image sensing device in some embodiments of the present disclosure performs vibration compensation by adjusting the position of the photosensitive element, so that the overall optical structure is simpler than that of the conventional OIS module by adjusting a lens position, to meet the market demand trend of increasingly light and thin lens design.

Although the present disclosure has been disclosed in the foregoing embodiments, the embodiments are not intended to limit the present disclosure. Any person with ordinary knowledge in the technical field may make some changes and refinements without departing from the spirit and scope of the present disclosure. Therefore, the protection scope of the present disclosure is subject to that defined in the attached patent claims.

What is claimed is:

1. An image sensing device, comprising:
a sensing module, comprising:
a circuit board, having a movable portion, a frame portion, and a plurality of connecting portions, wherein the connecting portions are connected to the movable portion and the frame portion; and
a photosensitive element, located in the movable portion;
a base;
a movable member, wherein the movable portion is located in the movable member;
a bearing assembly, located between the movable member and the base, to cause the movable member to be displaceable on a plane relative to the base; and
a plurality of memory metal elements, connected to the base and the movable member and electrically connected to the frame portion, wherein when the memory metal elements are driven, the movable member is actuated to move on the plane relative to the base.

2. The image sensing device according to claim 1, wherein the movable member comprises two block portions, the base comprises two turning portions and two accommodating portions, the two turning portions are respectively located at a pair of opposite corners of the base, the two accommodating portions are respectively located at another pair of opposite corners of the base, the two block portions are respectively located in the two accommodating portions, and each of the memory metal elements is connected to one of the two block portions and one of the two turning portions.

3. The image sensing device according to claim 2, wherein the movable member has a first conductive sheet, a second conductive sheet, a third conductive sheet, and a fourth conductive sheet, the first conductive sheet and the second conductive sheet are located in one of the two block portions, the third conductive sheet and the fourth conductive sheet are located in the other of the two block portions, the base has a first turning sheet and a second turning sheet, the first turning sheet and the second turning sheet are respectively located in the two turning portions, the memory metal elements comprise two first shape memory alloy (SMA) elements and two second SMA elements, the second conductive sheet, one of the two first SMA elements, the first turning sheet, one of the two second SMA elements, and the third conductive sheet are electrically connected in sequence, and the first conductive sheet, the other of the two second SMA elements, the second turning sheet, the other of the two first SMA elements, and the fourth conductive sheet are electrically connected in sequence.

4. The image sensing device according to claim 2, wherein a size of each of the block portions is less than a size of each of the two accommodating portions.

5. The image sensing device according to claim 1, wherein the bearing assembly comprises at least three spheres, at least three upper grooves located in the movable member, and at least three lower grooves located in the base, and each of the spheres is located between each of the upper grooves and each of the lower grooves.

6. The image sensing device according to claim 5, wherein a size of each of the upper grooves and a size of each of the lower grooves are greater than a size of each of the spheres.

7. The image sensing device according to claim 1, wherein the movable member comprises an upper magnetic element, the base comprises a lower magnetic element, the lower magnetic element is arranged on the base corresponding to the upper magnetic element, and the upper magnetic element and the lower magnetic element attract the movable member and the base through a magnetic attraction force.

8. The image sensing device according to claim 1, comprising a housing, wherein the housing has a groove and a groove edge, the base, the movable member, the bearing assembly, and the memory metal elements are arranged in the groove, the frame portion is connected to the groove edge, and when the memory metal elements are driven, the movable member is actuated to move on the plane relative to the base.

9. The image sensing device according to claim 1, wherein the memory metal elements are electrically connected to the movable member, the movable member is electrically connected to the movable portion, and the movable portion is connected to the frame portion through the connecting portions.

10. The image sensing device according to claim 1, wherein the connecting portions have flexibility, and the movable portion moves through the flexibility of the connecting portions.
